(19) United States
(12) Patent Application Publication
(10) Pub. No.: US 2006/0147212 A1
(43) Pub. Date: Jul. 6, 2006

(54) Optical filter, an optical interleaver and associated methods of manufacture

(76) Inventor: Roger Netterfield, New South Wales (AU)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 10/564,714

(22) PCT Filed: Jul. 14, 2004
(86) PCT No.: PCT/AU04/00947

§ 371 Date: Jan. 12, 2006

(30) Foreign Application Priority Data
Jul. 14, 2003 (AU) 2003903606

(51) Int. Cl. H04J 14/02

(52) U.S. Cl. 398/85

(57) ABSTRACT

The optical filter (1) receives a dense wavelength division multiplexed signal (2) as an input. The filter (1) is adapted to output a single channel (3) of less than 1 nm bandwidth. The filter (1) has a plurality of cavities (4) which are each optically connected to an adjacent cavity (4) by means of a coupling layer (8) one or more) cavities (4) include a spacer (5) of thickness greater than 7 μm. Each spacer (5) defines two opposed surfaces (6) each having a plurality of thin layers 7 disposed thereon. Preferably the total number of thin layers (7) per cavity (4) is less than 35. Also disclosed are optical interleavers.

### TECHNICAL FIELD

The present invention relates to an optical filter, an optical interleaver and associated methods of manufacture. The invention has been developed primarily for use in dense wavelength division multiplexing (DWDM) and de-multiplexing in telecommunications applications and will be described hereinafter with reference to this application. However it will be appreciated that the invention is not limited to this particular field of use.

### BACKGROUND ART

Prior art DWDM's generally fall into two categories, those using an in-fibre Bragg grating, and those utilising thin film coatings, known as narrow band filters. The preferred embodiment of the present invention falls generally into the narrow band filter category.

Some typical prior art narrow band filters are disclosed in U.S. Pat. No. 6,008,920, although the bandpass of these filters is generally not as narrow as that of the preferred embodiments of the present invention. Those prior art filters have multiple cavities to square up the bandpass, and each cavity is usually characterised by a centre layer in the form of a thin spacer. The optical thickness of each spacer is a multiple (M) multiplied by half the applicable wavelength, where M is a small integer (typically less than 6, often 1 or 2). In other words, the thickness of each spacer is typically within in the range of approximately 300 nm to 4 μm. This allows the spacers to be manufactured by thin film deposition techniques. FIG. 1 shows a typical structure for such a filter.

In mass production, prior art narrow band filters are constructed on large area substrates and later sliced and diced into many smaller devices (typically 1-2 mm square). To achieve the greatest number of useful devices per batch, the performance of the large area substrate must be very uniform. A major drawback to this technology, particularly as the bandwidth of the filter becomes smaller, is that it becomes more difficult to achieve sufficient uniformity of the layers over the aperture, and to tightly control the thicknesses of each layer with respect to the others. For these reasons, production yields are typically low, thereby increasing production costs and resulting in a relatively expensive end product.

FIG. 2 shows the predicted spectral transmittance of a typical prior art 50 GHz thin film narrow band filter centred at 1550 nm. This filter is illustrated in FIG. 1 and has a passband of 0.28 nm when measured as Full Width Half Maximum [or full-width to 3 db points]. FIG. 5 shows the spectral transmittance of the prior art filter in more detail over the typical wavelength range of an erbium doped fibre amplifier used in many optical telecommunications applications. The layer configuration of this prior art filter is:
(HL)ˆ10 HHLLL (HL)ˆ20 LLH (HL)ˆ21H (HL)ˆ10 0.59525H 0.73669L

where H and L refer to quarter-wave optical thickness layers of Ta₂O₆ and SiO₂ (refractive indices 2.065 and 1.465 respectively at 1550 nm). The filter consists of 126 layers (bearing in mind that two or more identical “layers” such as HH or LLL are actually counted as one layer) and has a total thickness of about 30 μm. The incident medium is air and the substrate glass. This prior art filter has three cavities with three corresponding spacers, each formed by the HH layer. Hence each spacer has an approximate thickness of 380 nm (for a narrow band filter centered on 1550 nm). Further, each cavity has the a total of approximately 41 thin layers (including the thin layers which together form the spacers).

Typically this prior art filter is used to transmit a narrow passband of marginally less than 0.5 nm, which may be centred within the wavelength range of telecommunications equipment such as erblum doped fibre amplifiers and lasers operating between about 1527 nm and 1567 nm.

The group delay across the passband is an important consideration when assessing the performance of a narrow pass filter. The group delay is proportional to the variation of the phase change on transmission across the pass band. A typical phase change for the prior art filter on transmission over a broad spectral range is illustrated in FIG. 3. More particularly, the phase change on transmission over the central pass band wavelength region for the prior art filter is illustrated in FIG. 4, with reference to the right hand Y axis. The variation of the phase change is approximately 305° or 1.7π. Also depicted with reference to the left hand Y axis of FIG. 4 is the spectral transmittance on transmission over the central pass band wavelength region for the prior art filter.

The effect of uniformity errors of 1 part in 50,000 In the thicknesses of the layers is illustrated in FIG. 6. In other words, all of the thicknesses of all of the layers are 1.000002 times thicker for the curve shown as a thick line as compared to standard curve without the errors shown as a thin line. FIG. 7 illustrates the effect of absorption in all the H layers of the prior art filter corresponding to an extinction coefficient k=0.0001 as the thick curve. Once again, the standard filter performance is illustrated by the thin line for comparative purposes.

Any discussion of the prior art throughout the specification should in no way be considered as an admission that such prior art is widely known or forms part of common general knowledge in the field.

It is an object of the present invention to overcome or ameliorate at least one of the disadvantages of the prior art, or to provide a useful alternative.

### DISCLOSURE OF THE INVENTION

According to a first aspect of the invention there is provided an optical filter having a plurality of cavities, one or more of said cavities including a spacer of thickness greater than 7 μm.

Preferably each spacer defines two opposed surfaces each having a plurality of thin layers disposed thereon, wherein the average number of thin layers per cavity is less than 35. Moreover, in some embodiments the average number of thin layers per cavity is substantially less than 35 and the thickness of each of the spacers is substantially greater than 7 μm.

According to a second aspect, the present invention provides an optical filter adapted to receive a dense wavelength division multiplexed optical signal including a plurality of channels ranging in frequency between approximately 1520 nm and 1570 nm, said filter being adapted to output a single channel of less than 1 nm width, said filter having a plurality of cavities, one or more of said cavities including a spacer of thickness greater than 7 μm and wherein said spacer defines two opposed surfaces each having a plurality of thin layers disposed thereon, wherein the average number of thin layers per cavity is less than 35.

According to a third aspect, the present invention provides an optical interleaver having a plurality of cavities, one or more of said cavities including a spacer of thickness greater than 7 μm.

According to a fourth aspect, the present invention provides an optical interleaver adapted to receive a dense wavelength division multiplexed optical input signal including a plurality of channels ranging in frequency between approximately 1520 nm and 1570 nm, said interleaver being adapted to split said input into an output of at least two sub-sets of channels, wherein each channel has a bandwidth in the range of about 16 nm to less than 1 nm, said interleaver having a plurality of cavities, one or more of said cavities including a spacer of thickness greater than 7 μm and wherein said spacer defines two opposed surfaces each having a plurality of thin layers disposed thereon, wherein the average number of thin layers per cavity is less than 35.

According to a fifth aspect, the present invention provides a method of manufacturing an optical filter as described above, said method including the steps of:

producing a plurality of spacers by optically polishing a substrate, wherein at least one of said spacers has a thickness of greater than 7 μm;

using thin film deposition to deposit a plurality of thin layers onto each of said spacers to form cavities, whereby the average number of thin layers per cavity is less than 35; and

optically contacting said plurality of cavities to form said filter.

According to a sixth aspect, the present invention provides a method of manufacturing an optical filter as described above, said method including the steps of:

a) utilising thick film deposition to produce a spacer having a thickness of greater than 7 μm;

b) utilising thin film deposition to deposit a plurality of thin layers onto said spacer to form a cavity, the average number of thin layers per cavity being less than 35;

c) repeating combinations of steps a) and b) so as to form said filter.

According to a seventh aspect, the present invention provides a method of manufacturing an optical interleaver as described above, said method including the steps of:

producing a plurality of spacers by optically polishing a substrate, wherein at least one of said spacers has a thickness of greater than 7 μm;

using thin film deposition to deposit a plurality of thin layers onto each of said spacers to form cavities, whereby the average number of thin layers per cavity is less than 35; and

optically contacting said plurality of cavities to form said interleaver.

According to another aspect, the present invention provides a method of manufacturing an optical interleaver as described above, said method including the steps of:

a) utilising thick film deposition to produce a spacer having a thickness of greater than 7 μm;

b) utilising thin film deposition to deposit a plurality of thin layers onto said spacer to form a cavity, the average number of thin layers per cavity being less than 35; and

c) repeating combinations of steps a) and b) so as to form said interleaver.

### BRIEF DESCRIPTION OF THE DRAWINGS

Preferred embodiments of the invention will now be described, by way of example only, with reference to the accompanying drawings in which:

FIG. 1 is a schematic diagram depicting a typical narrow band filter according to the prior art;

FIGS. 2 to 7 are graphs illustrating various performance characteristics of a typical example of the prior art filter according to FIG. 1, as described in more detail in the above discussion of the prior art;

FIGS. 8, 9 and 10 are graphs of the spectral transmittance of an output provided by a first embodiment of the present invention as compared to the prior art mentioned above;

FIG. 11 is a graph showing both the spectral transmittance and the phase change of an output provided by a first embodiment of the present invention as compared to the prior art mentioned above;

FIG. 12 is a graph showing the effects of an absolute error of 0.053 nm in spacer thickness to the output provided by a first embodiment of the present invention;

FIG. 13 is a graph showing the effects of an extinction coefficient of k=0.0001 In all of the H layers of the prior art mentioned above;

FIGS. 14 and 15 are graphs of the spectral transmittance of an output provided by a second embodiment of the present invention as compared to the prior art mentioned above;

FIGS. 16 and 17 are graphs of the spectral transmittance of an output provided by a third embodiment of the present invention as compared to the prior art mentioned above;

FIG. 18 is a graph showing the effect of an absolute error of 1.6 nm in the spacer thickness for the third embodiment of the invention;

FIG. 19 is a graph of the spectral transmittance of an output provided by a fourth embodiment of the present invention;

FIG. 20 is a graph showing both the spectral transmittance and the phase change of an output provided by the fourth embodiment of the present invention;

FIG. 21 is a graph showing the effects of an error in the thickness of the thin film layers in the fourth embodiment of 3 parts per 1000;

FIG. 22 is a graph of the spectral transmittance of an output provided by a fourth embodiment of the present invention;

FIGS. 23 and 24 are graphs of the spectral transmittance of an output provided by a fifth embodiment of the present invention;

FIG. 25 is a graph showing the effects of nonuniformity errors in the spacer thickness of the fifth embodiment;

FIGS. 26 and 27 are schematic diagrams illustrating the functioning of networks of preferred embodiments of interleavers according to the present invention;

FIGS. 28 and 29 are graphs of the spectral transmittance of outputs provided by a preferred embodiment of an interleaver according to the present invention;

FIG. 30 is a graph showing the effects of nonuniformity errors in the thin layers of the preferred embodiment of an interleaver according to the present invention;

FIG. 31 is a graph showing the effects of nonuniformity errors in the spacers of the preferred embodiment of an interleaver according to the present invention; and

FIGS. 32 and 33 are illustrations of the first embodiment of a filter according to the invention.

### DETAILED DESCRIPTION OF PREFERRED EMBODIMENTS OF THE INVENTION

### The First Preferred Embodiment of the Optical Filter

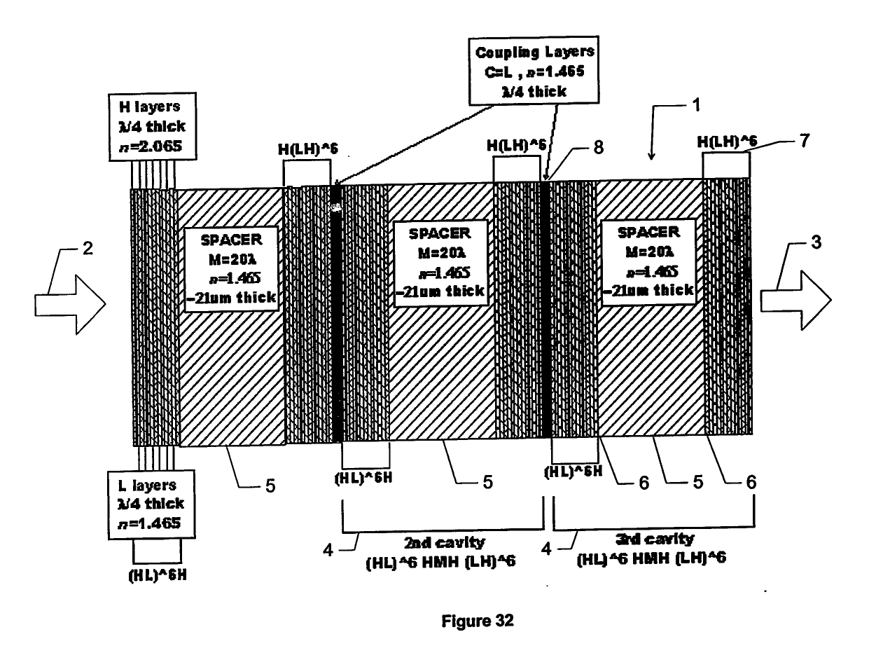

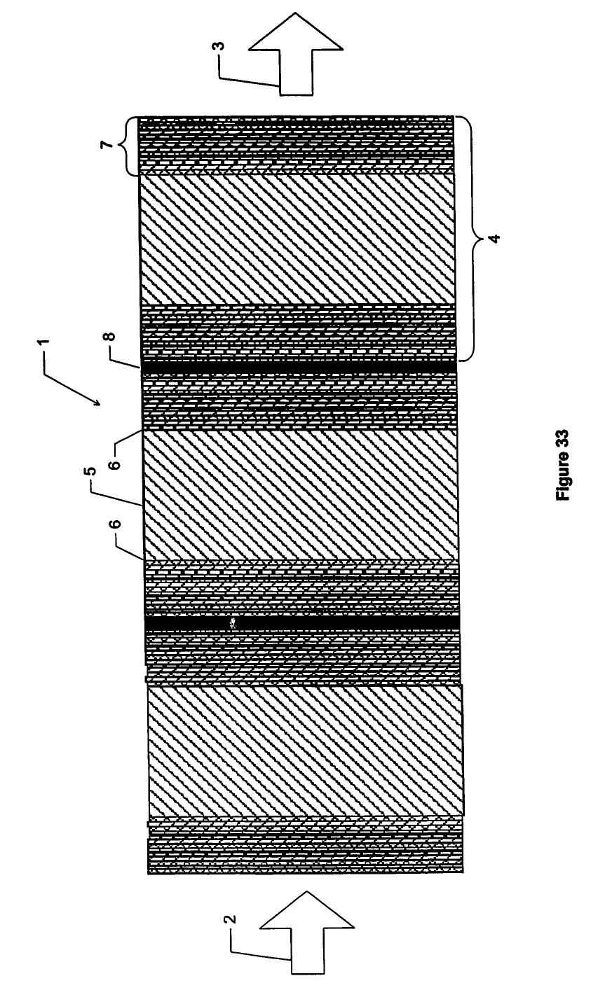

The first preferred optical filter 1 according to the present invention is illustrated in FIGS. 32 and 33, which are not to scale. The filter 1 is adapted to receive a dense wavelength division multiplexed optical signal 2 as an input. The signal 2 includes a plurality of channels ranging in frequency within a predetermined frequency range. Preferably the range is between approximately 1520 nm and 1570 nm, with 1527 nm to 1567 nm being the range utilised in the first preferred embodiment. The filter 1 is adapted to output a single channel 3 of less than 1 nm bandwidth. In other words, this filter allows a single channel to be extracted from a previously multiplexed signal. The filter 1 has a plurality of cavities 4 which are each optically connected to an adjacent cavity 4 by means of a coupling layer 8.

Preferably one or more of the cavities include a spacer 5 of thickness greater than 7 μm. In the first embodiment as illustrated each of the cavities 4 has a spacer 5 of 21 μm thickness. Other embodiments (not illustrated) have spacer thickness ranging between 7 μm up to greater than 1.5 mm. For example, some embodiments have spacer thicknesses of greater than: 10 μm, 20 μm, 50 μm, 100 μm, etc.

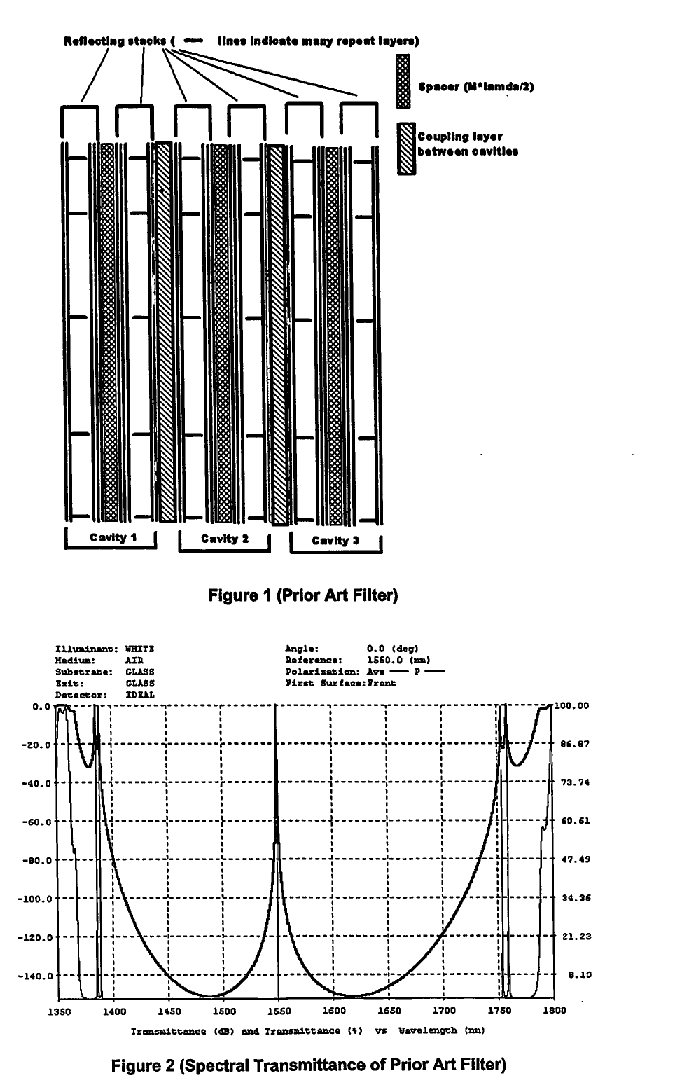

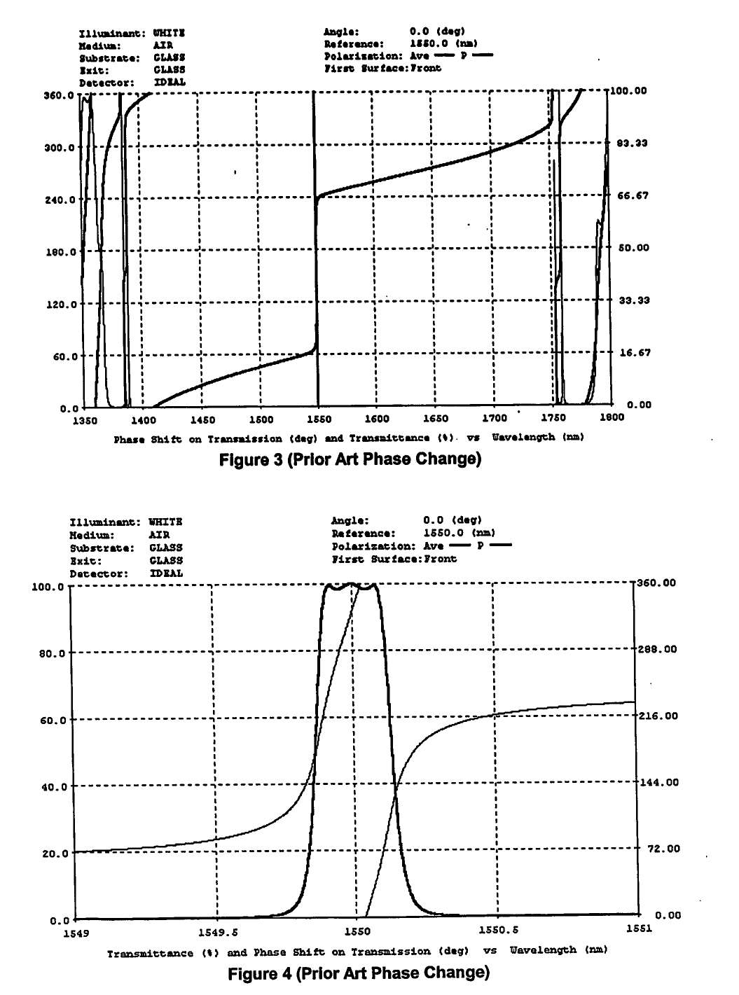

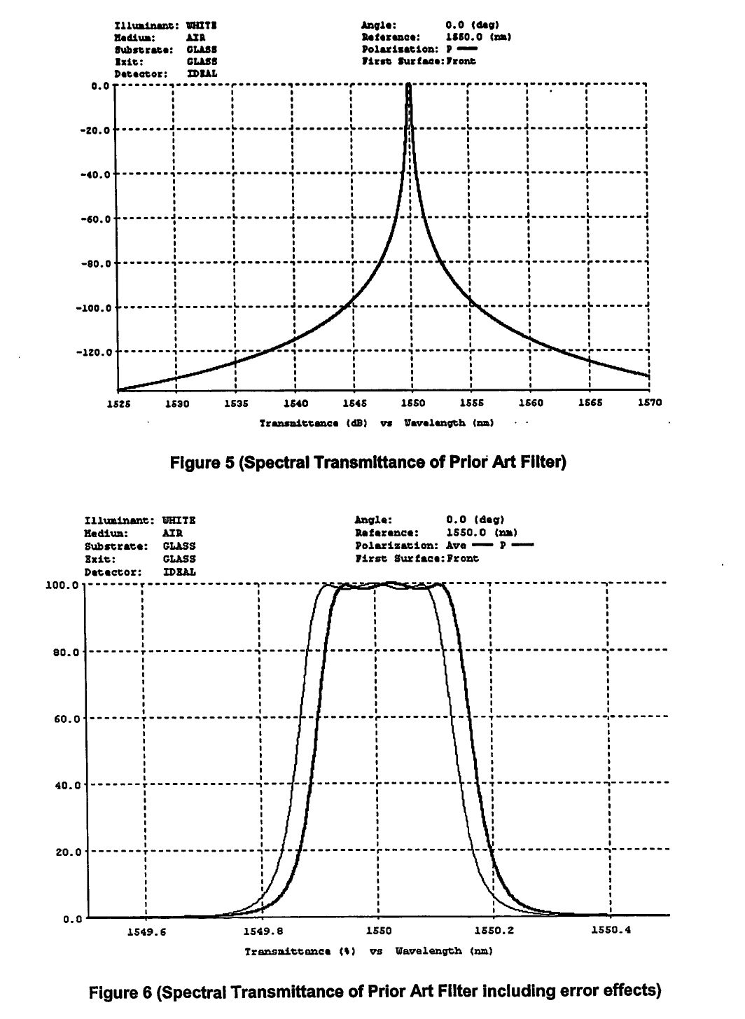

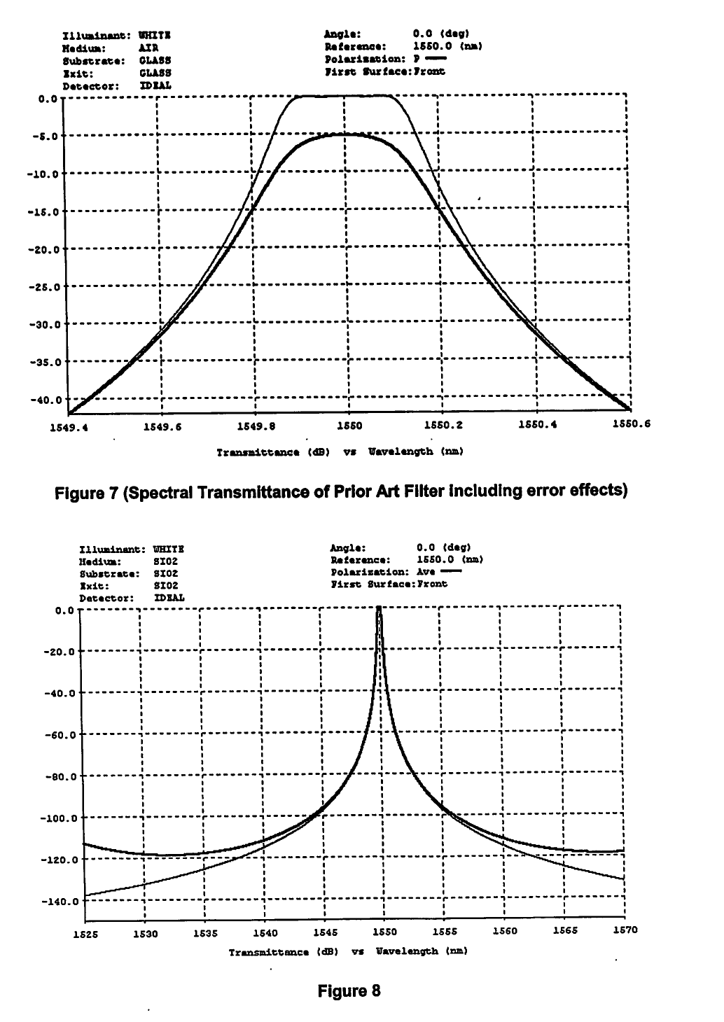

Each spacer 5 defines two opposed surfaces 6 each having a plurality of thin layers 7 disposed thereon. Preferably the average number of thin layers 7 per cavity 4 is less than 35 and in the illustrated embodiment the number of thin layers 7 per cavity 4 is 26. Other embodiments (not illustrated) have average numbers of thin layers 7 per cavity 4 of less than: 30, 25, 15, etc. The exact details as to the spacer thickness and number of thin layers per cavity will vary depending upon the particular function to be performed by the filter. For example, some embodiments of the invention (not illustrated) are engineered to provide a passband of less than 5 nm. Other embodiments have passbands of less than 1 nm or 0.5 nm. The illustrated embodiment has a passband of 0.28 nm centred at 1550 nm which is essentially identical to the passband of the prior art filter shown in FIG. 1.

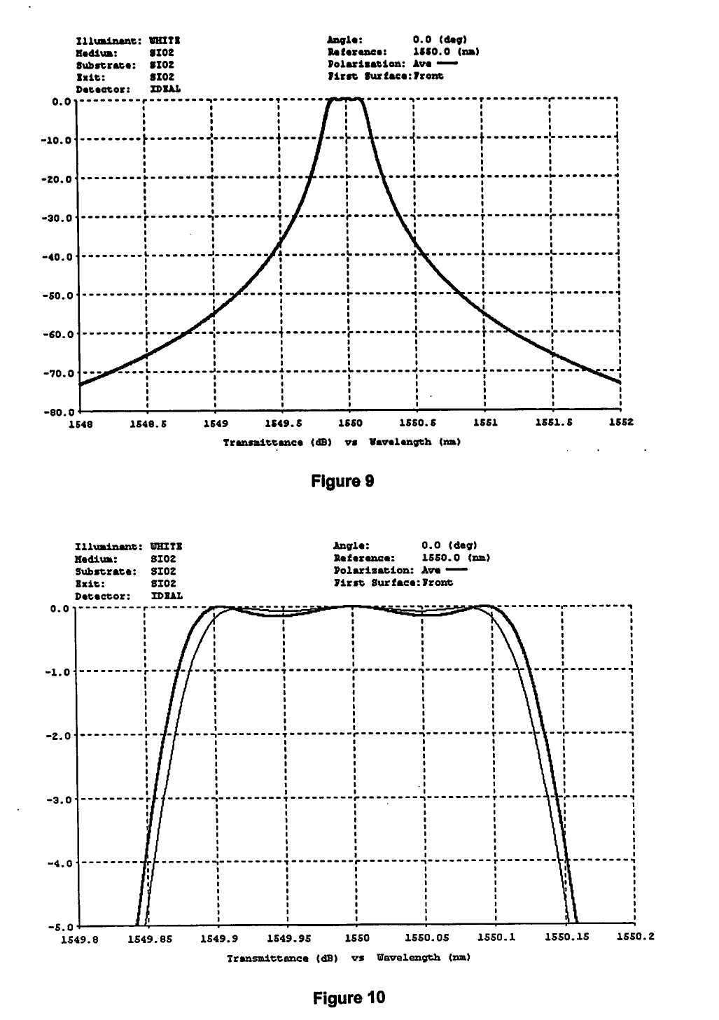

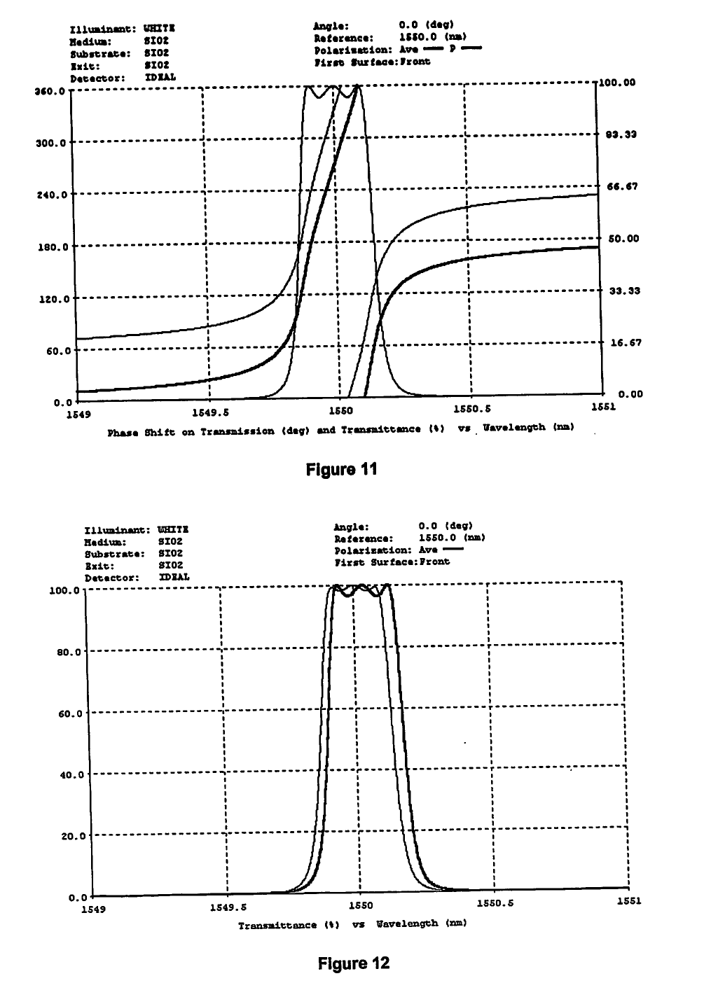

On FIGS. 8 to 11 the spectral transmittance of the first embodiment of the invention is shown as a thick line. This closely matches that of the example prior art filter shown in FIG. 1, the spectral transmittance of which is shown as the thin line in FIGS. 8 to 11. In particular, the spectral performance of the first embodiment and the prior art are compared over a broad bandwidth in FIG. 8. As attenuations of approximately 40 db are usually considered sufficient, the minor discrepancies between the two curves at attenuations of less than 100 db are functionally irrelevant. FIG. 9 shows that over a bandwidth of 1548 nm to 1552 nm the first embodiment almost perfectly matches the spectral performance of the prior art. FIG. 10 focuses more closely on the relative performances of the invention and the prior art over the central passband region. Once again, the two curves are closely matched. It can be seen from FIG. 11 that the two filters exhibit very similar variations in phase change on transmission across the passband. Hence the group delay of the two designs is very similar.

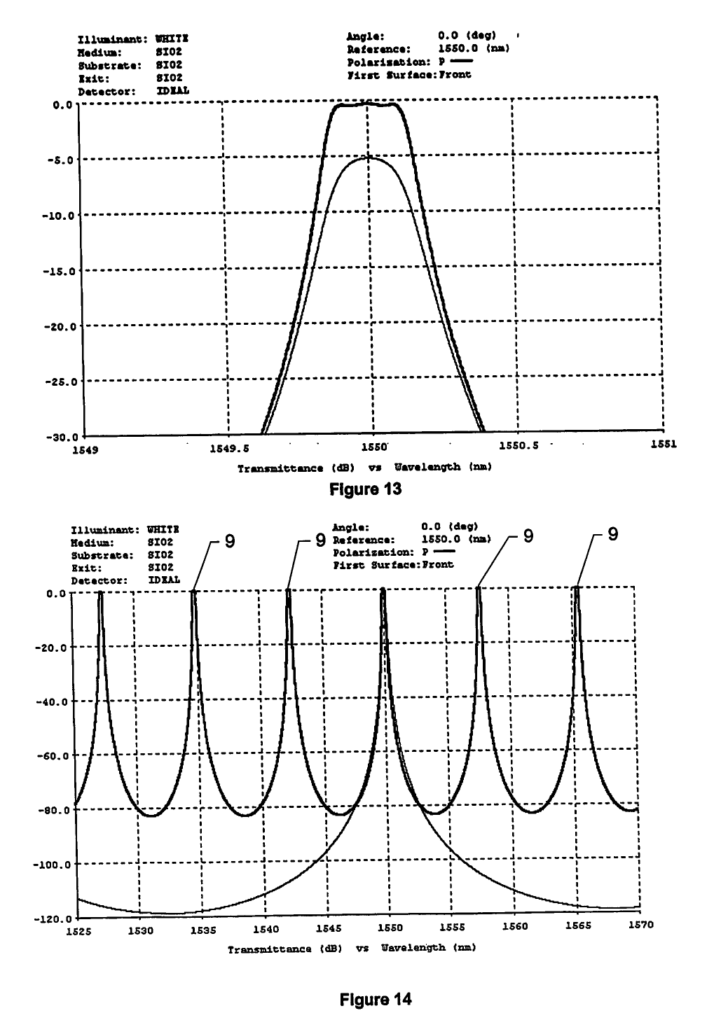

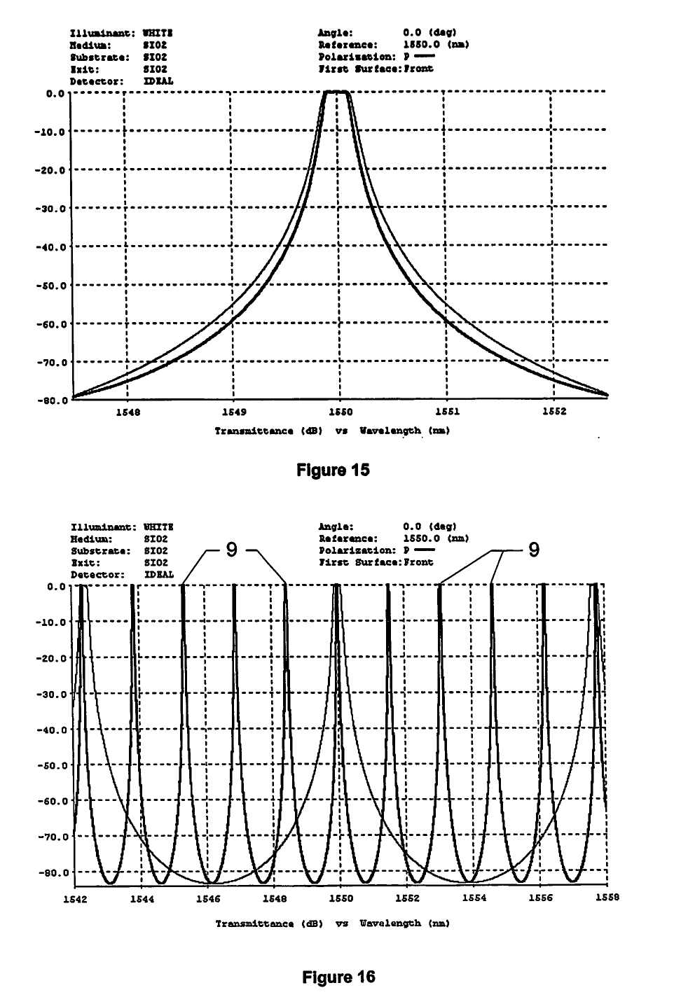

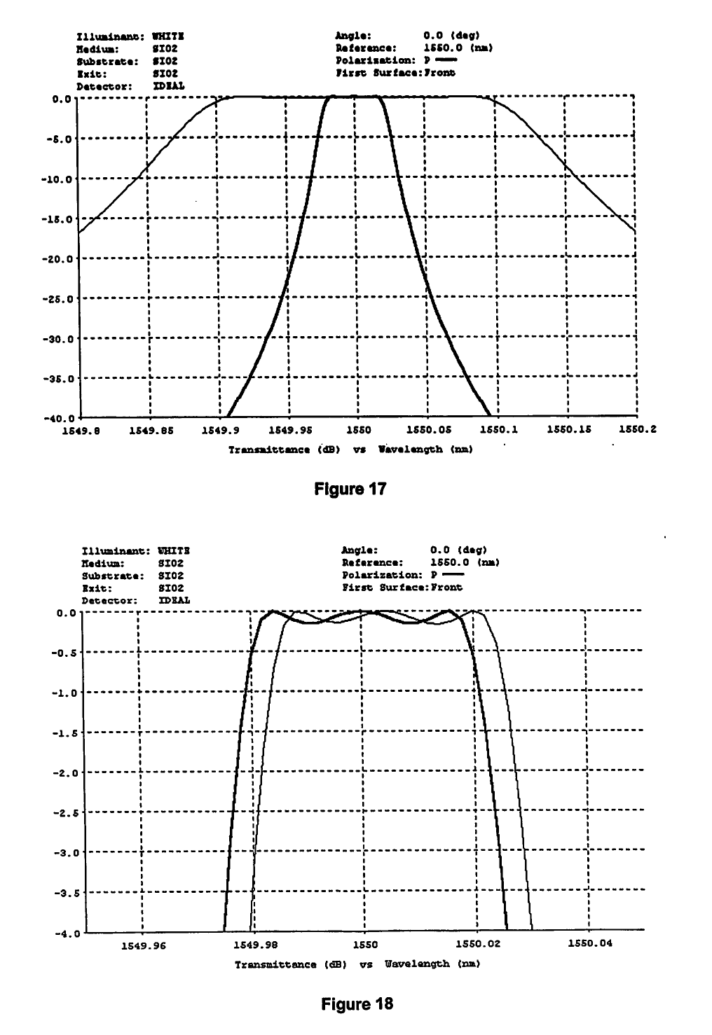

Advantageously however, the filter according to the first preferred embodiment requires significantly less thin layers as compared to the prior art mentioned above. Additionally, the first preferred embodiment may be manufactured with significantly relaxed tolerances as compared to the prior art in relation to parameters such as the thin layer uniformity and the acceptable degree of absorption. This is confirmed by FIGS. 12 and 13. The effect on the first preferred embodiment of an increase in the relative thicknesses due to non-uniformity in thin layers of 4 parts in 10,000 is illustrated in FIG. 12. The normal curve is shown as the thin line and the thick line shows the effects of the error. FIG. 12 may be compared to the effects caused in the prior art by an error in thin layer thickness of 1 part in 50,000 as illustrated in FIG. 6. The first embodiment is roughly 20 times less sensitive to errors in thin layer uniformity as the prior art filter mentioned above. FIG. 13 shows the effect of an extinction coefficient of k=1×10⁻⁴ for the first embodiment (thick line) as compared to the prior art mentioned above (thin line). It can be seen that the first embodiment is roughly ten times as tolerant to absorption as the prior art mentioned above.

Advantageously the first embodiment of the present invention is also tolerant to minor errors in the spacer thickness. Substantially the same effects as illustrated in FIG. 12 are caused by an absolute error of 0.53 nm in the spacer thickness.

The significantly relaxed tolerances of the first embodiment of the present invention allow the filter to be produced at a reduced cost. It also allows for increased yields for each product run. More particularly:
The maximum allowable uniformity error in the thickness of each of said thin layers is preferably within the range of 1 part in 50,000 to 4 parts in 10,000.
The maximum allowable absorption in each of said thin layers preferably corresponds to an extinction coefficient of between 1×10⁻⁴ and 1×10⁻⁵.
The maximum allowable uniformity error in the thickness of each of said spacers is preferably less than or equal to 0.53 nm.

Preferably at least one of the cavities is formed in accordance with the following formula:
(HL)ˆ6 HMH (LH)ˆ6
where H is a quarter wavelength layer of material having a refractive index of approximately 2.065, L is a quarter wavelength layer of material having a refractive index of approximately 1.465 and M is a spacer of approximately 21 μm thickness and having an approximate refractive index of 1.465.

Indeed, in the first embodiment of a filter according to the invention each of the cavities is formed in accordance with the above formula. Hence, the filter as a whole is given by:
((HL)ˆ6 HMH (LH)ˆ6 L)ˆ3
where H, L and M are as defined above and the final L layer on the right hand side of the formula acts as the coupling layer. The thin H layers are constructed from Ta₂O₆. The thin L layers, along with the spacers, are constructed from SiO₂. Of course, it will be appreciated by those skilled in the art that other materials, having different refractive indices, may be employed provided appropriate changes are made to the design of the filter.

The total thickness of the first embodiment is 82 μm, each spacer being 21 μm thick and each 13 layer reflective stack {that is (HL)ˆ6 H} is 3 μm thick. There is an average of approximately 26 layers per cavity in this embodiment.

### The Second Preferred Embodiment of the Optical Filter

In the second embodiment of the invention (not illustrated) at least one of the cavities is formed in accordance with the following formula:
(HL)ˆ4 HMH (LH)ˆ4
where H and L are defined as for the first embodiment and M is a spacer of approximately 106 μm thickness and having an approximate refractive index of 1.465. The spacer in this embodiment is roughly five times thicker than that in the first embodiment.

The second embodiment of the optical filter is in accordance with the following formula:
((HL)ˆ4 HMH (LH)ˆ4 L)ˆ3.
The spectral performance of the second embodiment of the invention over the band width of interest is illustrated in FIG. 14. It can be seen that unwanted adjacent side orders 9 are allowed to pass through this filter. Hence the second embodiment of the optical filter is preferably used in combination with a blocking filter having a passband of approximately 12 nm so as to block unwanted adjacent side orders 9.

The tolerances of this embodiment of the invention may be relaxed to a degree greater than those of the first embodiment:
The maximum allowable uniformity error in the thickness of each of said thin layers may fall within the range of 1 part in 50,000 to 3 parts in 2,000.
The maximum allowable uniformity error in the thickness of each of said the spacers is preferably less than or equal to 3.09 nm.

The second embodiment of the invention has a passband of approximately the same width as the first embodiment, along with a similar group delay. This embodiment has a total thickness of 3301 nm, each spacer being 1061 μm thick and each 9 layer reflecting stack {that is (HL)ˆ4 H} being about 2 μm thick. There is an average of approximately 18 thin layers per cavity in this embodiment.

### The Third Preferred Embodiment of the Optical Filter

In the third preferred embodiment of the optical filter at least one of the cavities is formed in accordance with the following formula:
(HL)ˆ4 HMH (LH)ˆ4
where H and L are defined as above and M is a spacer of approximately 529 μm thickness and having an approximate refractive index of 1.465. The optical filter of the third embodiment is in accordance with the following formula:
((HL)ˆ4 HMH (LH)ˆ4 L)ˆ3.

As may be seen from FIG. 16, unwanted adjacent side orders 9 are allowed to pass through this filter. Hence this embodiment may be used in combination with a blocking filter having a passband of approximately 2.4 nm so as to block adjacent side orders.

Tolerances for the third embodiment are:
The maximum allowable uniformity error in the thickness of each of said thin layers is within the range of 1 part in 50,000 to 1.2 parts in 1,000.
The maximum allowable uniformity error in the thickness of each of said spacers is less than or equal to 1.6 nm.

The third embodiment has a passband of less than 0.05 nm which is narrower than the prior art narrow band thin film filters known to the inventor. It has a total thickness of 1.6 mm, with each spacer being 529 μm. Each 9 layer reflecting stack {that is (HL)ˆ4 H} has a thickness of about 2 μm. The average number of thin layers per cavity is approximately 18.

### The Fourth Preferred Embodiment of the Optical Filter

The layer configuration for the fourth embodiment is in accordance with the following formula:
(HL)ˆ2 HMH (LH)ˆ2 L ((HL)ˆ3 HMH (LH)ˆ3 L)ˆ2 (HL)ˆ2 HMH (LH)ˆ2
where H and L are defined as above and M is a spacer of approximately 1.32 mm thickness and having an approximate refractive index of 1.465.

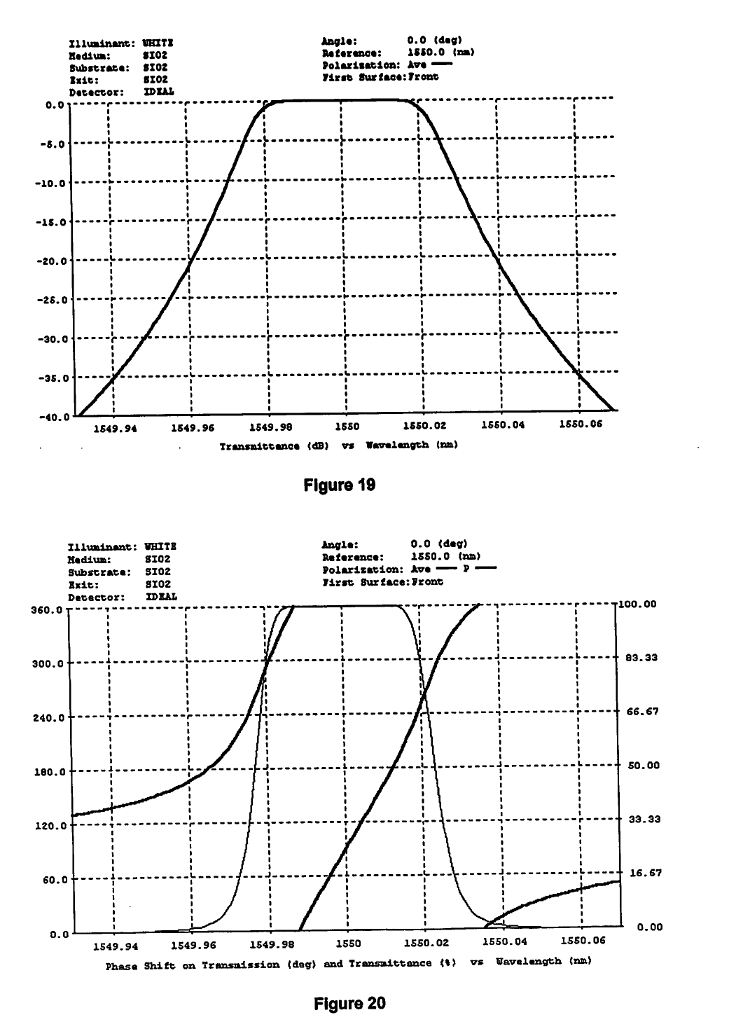

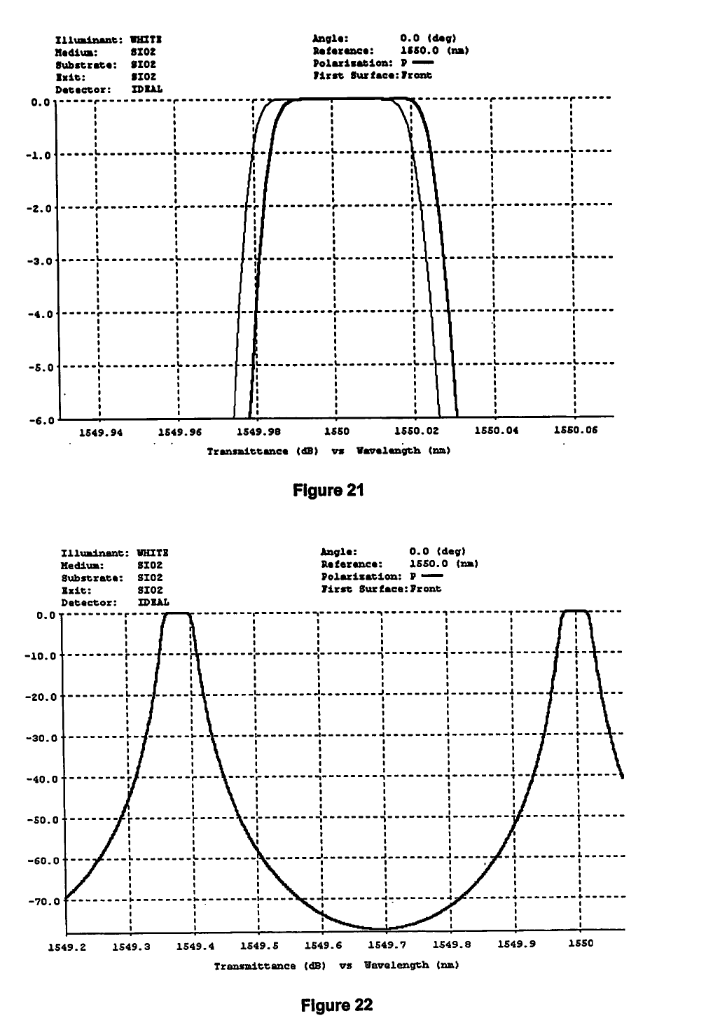

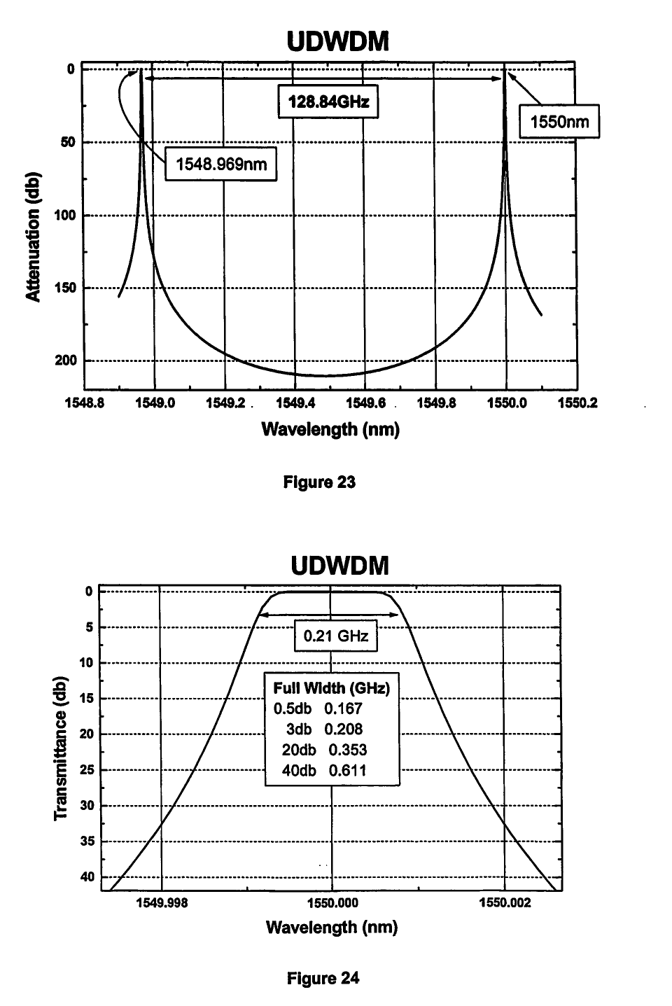

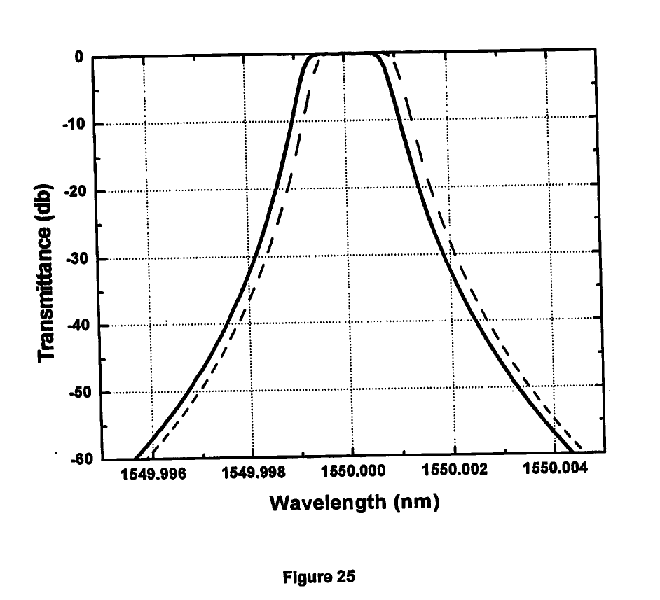

This embodiment is easier to manufacture than the first, second and third embodiments, however is only suitable for applications where a high group delay is acceptable. It can be seen from FIG. 19 that the passband is similar to that of the third embodiment. However, FIG. 20 shows that the variation of the phase change on transmission across the passband is greater that that of the previous embodiments.

It is preferable to use the fourth embodiment in combination with a blocking filter having a passband of approximately 1 nm so as to block adjacent side orders. The tolerances for this embodiment are further replaced as follows:
The maximum allowable uniformity error in the thickness of each of said thin layers is within the range of 1 part in 50,000 to 3 parts in 1,000.
The maximum allowable uniformity error in the thickness of each of said spacers is less than or equal to 3.96 nm.

The total thickness of the thin layers in the fourth embodiment is 11.5 μm, with each spacer being 1.32 mm.

Each of the first four embodiments of the filter show that performance roughly equal to, or better than, the example prior art filter shown in FIG. 1 can be achieved by the invention, however with far more relaxed tolerances and lesser number of thin layers. The next embodiment shows that if tolerances approaching those of the prior art are utilised, along with a greater number of thin layers, then performance far exceeding the state-of-the-art may be achieved.

### The Fifth Preferred Embodiment of the Optical Filter

The fifth embodiment is in accordance with the following formula:
((HL)ˆ7 HMH (LH)ˆ7 L) ((HL)ˆ8 HMH (LH) ˆ8 L) ˆ2 ((HL) ˆ7 HMH (LH) ˆ7)
where H and L are defined as above and M is a spacer of approximately 0.8 mm thickness and having an approximate refractive index of 1.465.
Tolerances for this embodiment are:
The maximum allowable uniformity error in the thickness of each of said thin layers is within the range of 1 part in 50,000 to 1 part in 10,000.
the maximum allowable uniformity error in the thickness of each of said spacers is less than or equal to 0.11 nm.

The fifth embodiment of the optical filter has a passband of approximately 0.002 nm. This is radically smaller than any prior art known to the inventor as at the priority date. A 0.02 nm wavelength passband is equivalent to a 0.2 GHz frequency passband. The prior art filters having a passband of around 0.5 nm allow for approximately 40 to 80 channels. If other telecommunications equipment were sufficiently upgraded so as to support this embodiment of the invention, it would theoretically allow for a single channel to be extracted from a multiplexed input having approximately 15000 channels across a 30 nm bandwidth. This improvement in performance would allow the information carrying capacity of currently laid optical fibres to be dramatically increased, thereby helping to address the rapidly growing world wide demand for digital telecommunications, for example due to increases in internet usage.

### Preferred Methods for Manufacturing Filters According to the Invention

A first preferred method of manufacturing an optical filter 1 in accordance with the invention includes the steps of:

producing a plurality of spacers 5 by optically polishing a substrate, wherein at least one of said spacers 5 has a thickness of greater than 7 μm;

using thin film deposition to deposit a plurality of thin layers 7 onto each of said spacers 5 to form cavities 4, whereby the average number of thin layers 7 per cavity 4 is less than 35; and

optically contacting said plurality of cavities 4 to form said filter 1.

It will be appreciated that the spacer thicknesses tolerances required for manufacture of the preferred embodiments of the optical filter are within the capabilities of those skilled in the art of optical polishing. Similarly, the required thin layer tolerances are within the capabilities of those skilled in the art of thin film deposition.

The second preferred method of manufacturing an optical filter 1 in accordance with the invention includes the steps of:

a) utilising thick film deposition to produce a spacer 5 having a thickness of greater than 7 μm;

b) utilising thin film deposition to deposit a plurality of thin layers 7 onto said spacer 5 to form a cavity 4, the average number of thin layers 7 per cavity 4 being less than 35;

c) repeating combinations of steps a) and b) so as to form said filter 1.

In the exemplary preferred embodiments described above the spacer is made of SiO₂, a material with a relatively low refractive index in comparison to many other transparent materials at the wavelength range of interest (about 1550 nm). This type of filter is appropriate for applications which are tolerant of a high sensitivity to wavelength shift as a function of tilting with respect to the angle of incidence of the incident radiation. If such sensitivity is to be avoided, it is preferable to choose a spacer material with a higher refractive index, such as silicon. An additional advantage of using such a material is that it is more amenable to the second preferred method for manufacturing the filters which preferably uses automated equipment and procedures similar to those used in semiconductor fabrication technology. In yet further embodiments, various other crystalline and amorphous bulk materials are also used to make suitable spacers.

### Preferred Embodiment of an Optical Interleaver

Optical interleavers are adapted to receive a dense wavelength division multiplexed optical input signal including a plurality of channels within a predetermined frequency range and to split said input into an output of at least two sub-sets of channels. For example, an interleaver may divide the channels into odd and even sets, or into an upper half and a lower half. Often channels are separated such that some channels are reflected by the interleaver and others are transmitted through the interleaver.

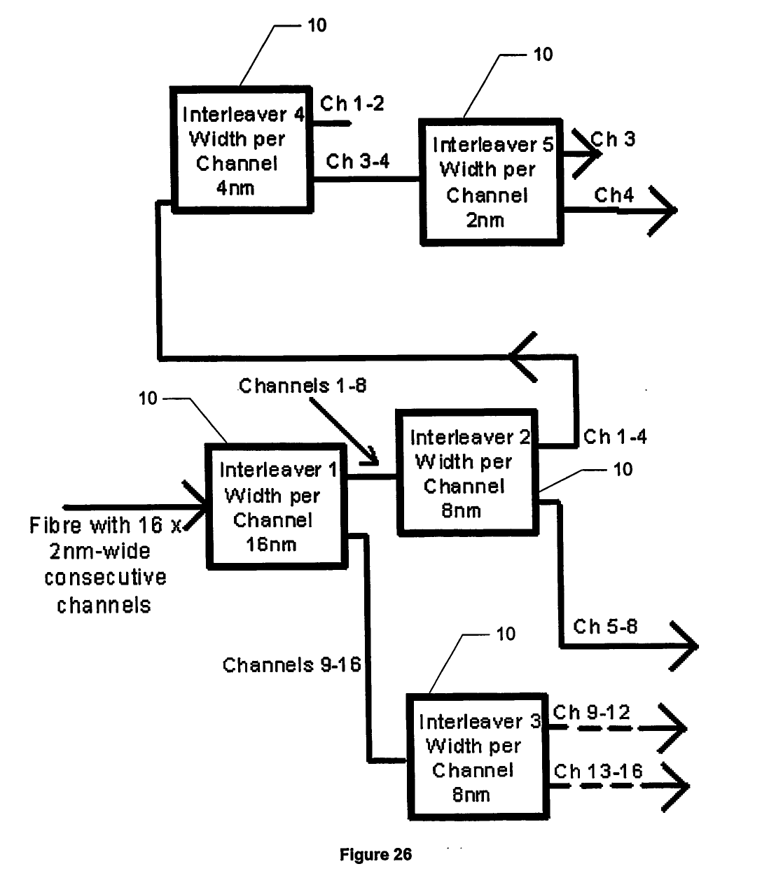

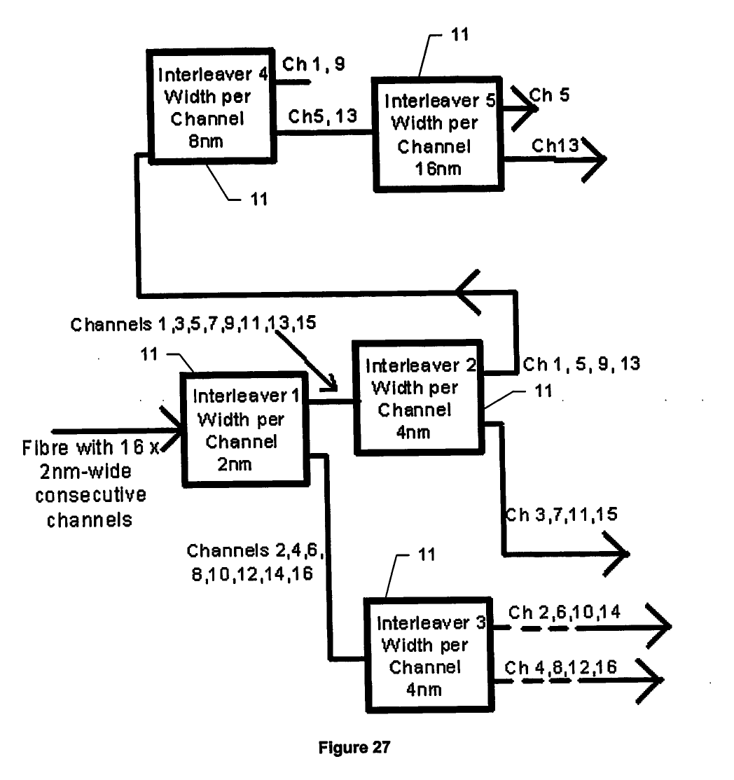

As is known from the prior art, a network of interleavers may be utilised to separate all of the channels from a multiplexed input signal. Examples of such networks are illustrated in FIGS. 26 and 27. Each of the interleavers 9 of the network in FIG. 26 split the input signal into upper and lower halves. Each of the interleavers 10 of the network in FIG. 27 split the input signal into alternate odd and even channels.

The preferred embodiment of the interleaver has a plurality of cavities, one or more of the cavities including a spacer of thickness greater than 7 μm. Each spacer defines two opposed surfaces each having a plurality of thin layers disposed thereon, wherein the average number of thin layers per cavity is less than 35. Other embodiments of the interleaver have an average number of thin layers per cavity is less than 30, 25, 15 or 10. The thickness of the spacer is preferably greater than 10 μm, although in other embodiments it is greater than 20 μm, 50 μm or 100 μM. Each of the channels separated by the preferred embodiment preferably has a bandwidth of less than 5 μm, although some preferred embodiments are capable of separating channels of less than 1 μm or 0.5 μm. The predetermined frequency range within which the channels of the input signal are multiplexed is typically approximately 1520 nm to 1570 nm for telecommunications, although other ranges may be employed for various applications.

At least one of the cavities of the preferred embodiment is formed in accordance with the following formula:
HLHM
where H is a quarter wavelength layer of material having a refractive index of approximately 2.065, L is a quarter wavelength layer of material having a refractive index of approximately 1.465 and M is a spacer of approximately 0.8 mm thickness and having an approximate refractive index of 1.465.

More particularly, the overall preferred interleaver is formed in accordance with the following formula:
(HLHM)ˆ10 HLH
This is a 10-cavity filter which is preferably optimised to reduce ripple. In the preferred embodiment each of the H layers is constructed from Ta₂O₅, and the L layers are constructed from SiO₂. The 0.8 mm thick M layers, that is the spacers, are also constructed from SiO₂. The total thickness of the interleaver is approximately 8 mm, consisting of a total of 41 layers (optimised down from the starting design of 43 layers, 3 S 3 S 3 S . . . ). There are 10 high order thick layers and 31 λ/4 layers.

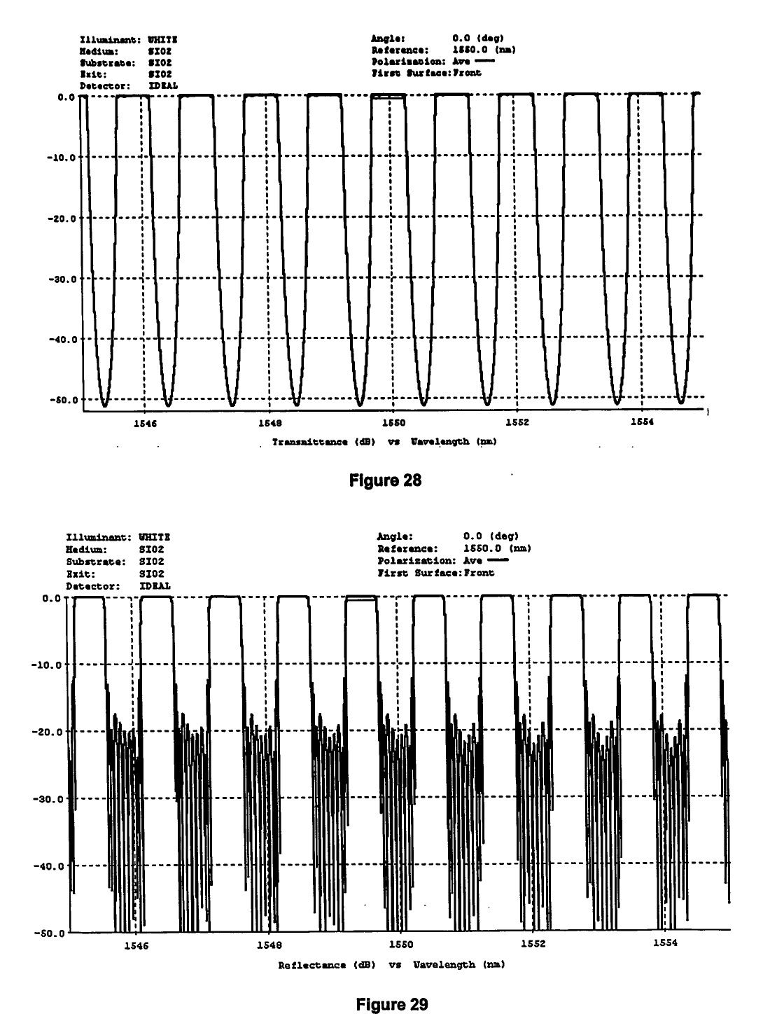

FIGS. 28 and 29 show the spectral transmittance and reflectance respectively of the preferred embodiment. It can be seen that the preferred embodiment divides the input signal into alternate odd and even channels.

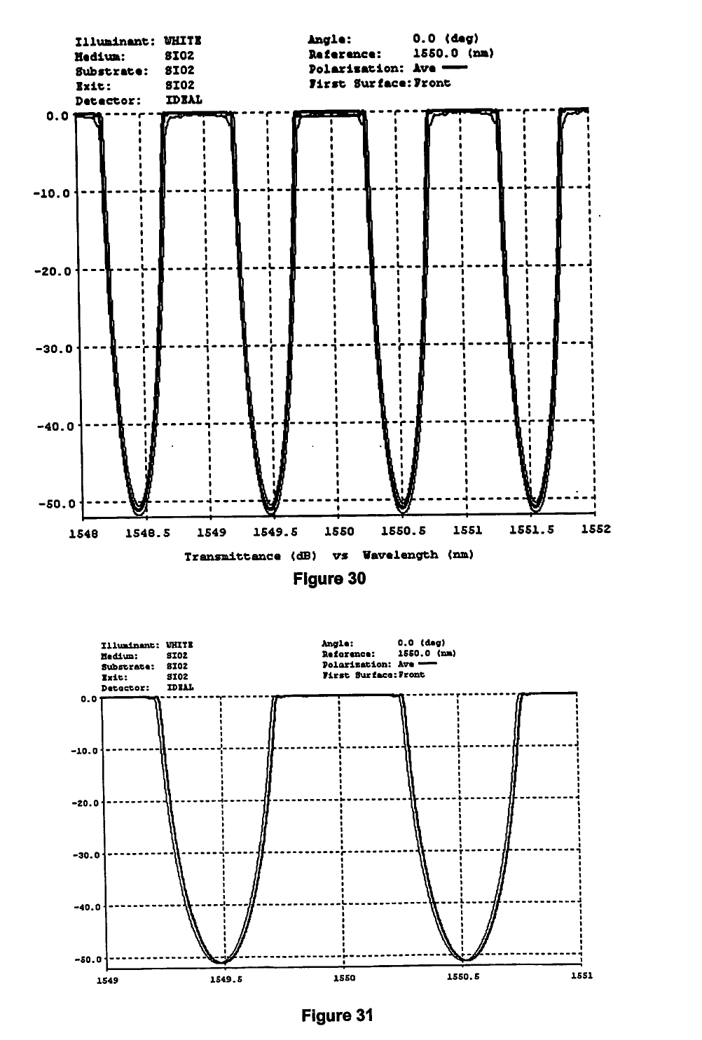

As was the case for the filter described above, the tolerances for the interleaver are relatively relaxed compared to the prior art. The maximum allowable uniformity error in the thickness of each of said thin layers is preferably equal to or less than 5 nm. The maximum allowable uniformity error in the thickness of each of said spacers is equal to or less than 8 nm. FIGS. 30 and 31 show the effects of these errors respectively.

### Preferred Methods for Manufacturing Interleavers According to the Invention

A first preferred method of manufacturing an optical interleaver as described above includes the steps of:

producing a plurality of spacers by optically polishing a substrate, wherein at least one of said spacers has a thickness of greater than 7 μm;

using thin film deposition to deposit a plurality of thin layers onto each of said spacers to form cavities, whereby the average number of thin layers per cavity is less than 35; and

optically contacting said plurality of cavities to form said interleaver. An alternative preferred method of manufacturing an optical filter as described above includes the steps of:

a) utilising thick film deposition to produce a spacer having a thickness of greater than 7 μm;

b) utilising thin film deposition to deposit a plurality of thin layers onto said spacer to form a cavity, the average number of thin layers per cavity being less than 35; and

c) repeating combinations of steps a) and b) so as to form said interleaver.

Although the invention has been described with reference to specific examples, it will be appreciated by those skilled in the art that it may be embodied in many other forms.

The claims defining the invention are as follows:

1. An optical filter having a passband of less than 1 nm, said filter including a plurality of cavities, one or more of said cavities including a spacer of thickness greater than 7 μm, said spacer defining two opposed surfaces each having a plurality of thin layers disposed thereon, wherein the total number of thin layers per cavity is less than 35 and wherein the maximum allowable uniformity error in the thickness of each of said thin layers is within the range of 1 part in 50,000 to 3 parts in 1000.

2. An optical filter according to claim 1 wherein the thickness of the spacer is greater than 10 μm.

3. An optical filter according to any one of the preceding claims wherein the thickness of the spacer is greater than 20 μm.

4. An optical filter according to any one of the preceding claims wherein the thickness of the spacer is greater than 50 μm.

5. An optical filter according to any one of the preceding claims wherein the thickness of the spacer is greater than 100 μm.

6. An optical filter according to any one of the preceding claims wherein the average number of thin layers per cavity is less than 30.

7. An optical filter according to any one of the preceding claims wherein the average number of thin layers per cavity is less than 25.

8. An optical filter according to any one of the preceding claims wherein the average number of thin layers per cavity is less than 15.

9. An optical filter according to any one of the preceding claims wherein said filter has a passband of less than 0.5 nm.

10. An optical filter according to any one of the preceding claims wherein said filter is adapted to receive a dense wavelength division multiplexed optical signal including a plurality of channels within a predetermined frequency range.

11. An optical filter according to claim 10 wherein said predetermined frequency range is approximately 1520 nm to 1570 nm.

12. An optical filter according to any one of the preceding claims wherein at least one of the cavities is formed in accordance with the following formula:
(HL)ˆ6 HMH (LH) ˆ6
where H is a quarter wavelength layer of material having a refractive index of approximately 2.065, L is a quarter wavelength layer of material having a refractive index of approximately 1.465 and M is a spacer of approximately 21 μm thickness and having an approximate refractive index of 1.465.

13. An optical filter according to any one of the preceding claims wherein said optical filter is in accordance with the following formula:
((HL)ˆ6 HMH (LH)ˆ6 L)ˆ3
where H is a quarter wavelength layer of material having a refractive index of approximately 2.065, L is a quarter wavelength layer of material having a refractive index of approximately 1.465 and M is a spacer of approximately 21 μm thickness and having an approximate refractive index of 1.465.

14. An optical filter according to claim 12 or 13 wherein the maximum allowable uniformity error in the thickness of each of said thin layers is within the range of 1 part in 50,000 to 4 parts in 10,000.

15. An optical filter according to any one of the preceding claims wherein the maximum allowable absorption in each of said thin layers corresponds to an extinction coefficient of between 1×10⁻⁴ and 1×10⁻⁵.

16. An optical filter according to any one of the preceding claims wherein the maximum allowable uniformity error in the thickness of each of said spacers is less than or equal to 0.53 nm.

17. An optical filter according to any one of claims 1 to 11 wherein at least one of the cavities is formed in accordance with the following formula:
(HL)ˆ4 HMH (LH)ˆ4
where H is a quarter wavelength layer of material having a refractive index of approximately 2.065, L is a quarter wavelength layer of material having a refractive index of approximately 1.465 and M is a spacer of approximately 106 μm thickness and having an approximate refractive index of 1.465.

18. An optical filter according to any one of claims 1 to 11 wherein said optical filter is in accordance with the following formula:
((HL)ˆ4 HMH (LH)ˆ4 L)ˆ3
where H is a quarter wavelength layer of material having a refractive index of approximately 2.065, L is a quarter wavelength layer of material having a refractive index of approximately 1.465 and M is a spacer of approximately 106 μm thickness and having an approximate refractive index of 1.465.

19. An optical filter according to claim 17 or 18 wherein said optical filter is used in combination with a blocking filter having a passband of approximately 12 nm so as to block adjacent side orders.

20. An optical filter according to any one of claims 17 to 19 wherein the maximum allowable uniformity error in the thickness of each of said thin layers is within the range of 1 part in 50,000 to 3 parts in 2,000.

21. An optical filter according to any one of claims 1 to 11 wherein at least one of the cavities is formed in accordance with the following formula:
(HL)ˆ4 HMH (LH)ˆ4
where H is a quarter wavelength layer of material having a refractive index of approximately 2.065, L is a quarter wavelength layer of material having a refractive index of approximately 1.465 and M is a spacer of approximately 529 μm thickness and having an approximate refractive index of 1.465.

22. An optical filter according to any one of claims 1 to 11 wherein said optical filter is in accordance with the following formula:
((HL)ˆ4 HMH (LH)ˆ4 L)ˆ3
where H is a quarter wavelength layer of material having a refractive index of approximately 2.065, L is a quarter wavelength layer of material having a refractive index of approximately 1.465 and M is a spacer of approximately 5291 μm thickness and having an approximate refractive index of 1.465.

23. An optical filter according to claim 21 or 22 wherein said optical filter is used in combination with a blocking filter having a passband of approximately 2.4 nm so as to block adjacent side orders.

24. An optical filter according to any one of claims 21 to 23 wherein said filter has a passband of less than 0.05 nm.

25. An optical filter according to any one of claims 21 to 24 wherein the maximum allowable uniformity error in the thickness of each of said thin layers is within the range of 1 part in 50,000 to 1.2 parts in 1,000.

26. An optical filter according to any one of claims 21 to 25 wherein the maximum allowable uniformity error in the thickness of each of said spacers is less than or equal to 1.6 nm.

27. An optical filter according to any one of claims 1 to 11 wherein said optical filter is in accordance with the following formula:
(HL)ˆ2 HMH (LH)ˆ2 L ((HL)ˆ3 HMH (LH)ˆ3 L)ˆ2 (HL)ˆ2 HMH (LH)ˆ2
where H is a quarter wavelength layer of material having a refractive index of approximately 2.065, L is a quarter wavelength layer of material having a refractive index of approximately 1.465 and M is a spacer of approximately 1.32 mm thickness and having an approximate refractive index of 1.465.

28. An optical filter according to claim 27 wherein said optical filter is used in combination with a blocking filter having a passband of approximately 1 nm so as to block adjacent side orders.

29. An optical filter according to any one of claims 27 to 28 wherein the maximum allowable uniformity error in the thickness of each of said spacers is less than or equal to 3.96 nm.

30. An optical filter according to any one of claims 1 to 11 wherein said optical filter is in accordance with the following formula:
((HL)ˆ7 HMH (LH)ˆ7 L) ((HL)ˆ8 HMH (LH)ˆ8 L)ˆ2 ((HL)ˆ7 HMH (LH)ˆ7)
where H is a quarter wavelength layer of material having a refractive index of approximately 2.065, L is a quarter wavelength layer of material having a refractive index of approximately 1.465 and M is a spacer of approximately 0.8 mm thickness and having an approximate refractive index of 1.465.

31. An optical filter according to claim 30 wherein the maximum allowable uniformity error in the thickness of each of said thin layers is within the range of 1 part in 50,000 to 1 part in 10,000.

32. An optical filter according to any one of claims 30 or 31 wherein the maximum allowable uniformity error in the thickness of each of said spacers is less than or equal to 0.11 nm.

33. An optical filter according to any one of claims 30 to 32 wherein said filter has a passband of approximately 0.002 nm.

34. An optical interleaver having a passband of less than 1 nm, the interleaver including a plurality of cavities, one or more of said cavities including a spacer of thickness greater than 7 μm, said spacer defining two opposed surfaces each having a plurality of thin layers disposed thereon, wherein the average number of thin layers per cavity is less than 35 and wherein the maximum allowable uniformity error in the thickness of each of the thin layers is within the range of 1 part in 50,000 to 3 parts in 1000.

35. An optical interleaver according to claim 34 wherein the average number of thin layers per cavity is less than 30.

36. An optical interleaver according to claim 34 or 35 wherein the thickness of the spacer is greater than 10 μm.

37. An optical interleaver according to claim 34 or 35 wherein the thickness of the spacer is greater than 20 μm.

38. An optical interleaver according to claim 34 or 35 wherein the thickness of the spacer is greater than 50 μm.

39. An optical interleaver according to claim 34 or 35 wherein the thickness of the spacer is greater than 100 μm.

40. An optical interleaver according to any one of claims 34 to 39 wherein the total number of thin layers per cavity is less than 25.

41. An optical interleaver according to any one of claims 34 to 39 wherein the total number of thin layers per cavity is less than 15.

42. An optical interleaver according to any one of claims 34 to 39 wherein the total number of thin layers per cavity is less than 10.

43. An optical interleaver according to any one of claims 34 to 42 wherein each of said channels has a bandwidth of less than 0.5 μm.

44. An optical interleaver according to any one of claims 34 to 43 wherein at least one of the cavities is formed in accordance with the following formula:
HLHM
where H is a quarter wavelength layer of material having a refractive index of approximately 2.065, L is a quarter wavelength layer of material having a refractive index of approximately 1.465 and M is a spacer of approximately 0.8 mm thickness and having an approximate refractive index of 1.465.

45. An optical interleaver according to any one of claims 34 to 44 wherein said interleaver is formed in accordance with the following formula:
(HLHM)ˆ10 HLH
where H is a quarter wavelength layer of material having a refractive index of approximately 2.065, L is a quarter wavelength layer of material having a refractive index of approximately 1.465 and M is a spacer of approximately 0.8 mm thickness and having an approximate refractive index of 1.465.

46. An optical interleaver according to any one of claims 34 to 45 wherein the maximum allowable uniformity error in the thickness of each of said thin layers is equal to or less than 5 nm.

47. An optical interleaver according to any one of claims 34 to 46 wherein the maximum allowable uniformity error in the thickness of each of said spacers is equal to or less than 8 nm.

48. An optical interleaver adapted to receive a dense wavelength division multiplexed optical input signal including a plurality of channels ranging in frequency between approximately 1520 nm and 1570 nm, said interleaver being adapted to split said input into an output of at least two sub-sets of channels, wherein each channel has a bandwidth of less than 1 nm, said interleaver having a plurality of cavities, one or more of said cavities including a spacer of thickness greater than 7 μm and wherein said spacer defines two opposed surfaces each having a plurality of thin layers disposed thereon, wherein the average number of thin layers per cavity is less than 35 and wherein the maximum allowable uniformity error in the thickness of each of said thin layers is within the range of 1 part in 50,000 to 3 parts in 1000.

49. A method of manufacturing an optical filter in accordance with any one of claims 1 to 33, said method including the steps of:
producing a plurality of spacers by optically polishing a substrate, wherein at least one of said spacers has a thickness of greater than 7 μm;
using thin film deposition to deposit a plurality of thin layers onto each of said spacers to form cavities, whereby the average number of thin layers per cavity is less than 35 and wherein the maximum allowable uniformity error in the thickness of each of said thin layers is within the range of 1 part in 50,000 to 3 parts in 1000; and
optically contacting said plurality of cavities to form said filter.

50. A method of manufacturing an optical filter in accordance with any one of claims 1 to 33, said method including the steps of:
a) utilising thick film deposition to produce a spacer having a thickness of greater than 7 μm;
b) utilising thin film deposition to deposit a plurality of thin layers onto said spacer to form a cavity, the average number of thin layers per cavity being less than 35 and wherein the maximum allowable uniformity error in the thickness of each of said thin layers is within the range of 1 part in 50,000 to 3 parts in 1000; and
c) repeating combinations of steps a) and b) so as to form said filter.

51. A method of manufacturing an optical interleaver in accordance with any one of claims 34 to 48, said method including the steps of:
producing a plurality of spacers by optically polishing a substrate, wherein at least one of said spacers has a thickness of greater than 7 μm;
using thin film deposition to deposit a plurality of thin layers onto each of said spacers to form cavities, whereby the average number of thin layers per cavity is less than 35 and wherein the maximum allowable uniformity error in the thickness of each of said thin layers is within the range of 1 part in 50,000 to 3 parts in 1000; and
optically contacting said plurality of cavities to form said interleaver.

52. A method of manufacturing an optical interleaver in accordance with any one of claims 34 to 48, said method including the steps of:
a) utilising thick film deposition to produce a spacer having a thickness of greater than 7 μm;
b) utilising thin film deposition to deposit a plurality of thin layers onto said spacer to form a cavity, the average number of thin layers per cavity being less than 35 and wherein the maximum allowable uniformity error in the thickness of each of said thin layers is within the range of 1 part in 50,000 to 3 parts in 1000; and
c) repeating combinations of steps a) and b) so as to form said interleaver.
